(19) United States
(12) Patent Application Publication
(10) Pub. No.: US 2002/0012504 A1
(43) Pub. Date: Jan. 31, 2002

(54) Angled fiber optic connector

(76) Inventors: Frederick J. Gillham, Westborough, MA (US); Gregory B. Papazian, Worcester, MA (US); David W. Stowe, Milford, MA (US); Gary N. Warner, Attleboro, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/799,811

(22) Filed: Mar. 5, 2001

Related U.S. Application Data
(60) Provisional application No. 60/187,186, filed on Mar. 6, 2000.

(51) Int. Cl. G02B 6/36

(52) U.S. Cl. 385/86; 385/76; 385/78

(57) ABSTRACT

An angled fiber optical connector which includes a curved body portion that includes an internal passageway and a treated optical fiber disposed within the internal passageway. The treated optical fiber has been annealed or otherwise treated to reduce the micromechanical stresses within the fiber in order to reduce the degradation of the optical and physical properties of the fiber. In addition, the treated portion of the optical fiber disposed within the internal passageway can be configured and arranged to prevent physical contact with any of the interior surfaces of the internal passageway.

### CROSS REFERENCE TO RELATED APPLICATIONS

This application claims the benefit under 35 U.S.C. §119(e) of U.S. Provisional Application No. 60/187,186, filed Mar. 6, 2000, the entire disclosure of which is incorporated herein by reference.

### STATEMENT REGARDING FEDERALLY SPONSORED RESEARCH OR DEVELOPMENT

N/A

### BACKGROUND OF THE INVENTION

This invention relates to fiber optic connectors and in particular to an optical fiber connector having an angled portion.

It is well known that optical fibers have a larger signal bandwidth than copper conductors. As such, optical fibers are increasingly being used in present day communications systems to facilitate higher bandwidth communications and/or a larger number of users per system.

Optical fibers however, have the physical disadvantage of being more fragile than metallic copper wire and therefore the handling and routing of optical fibers and cables requires extra precautions. For example, there is a limit to the amount that an optical fiber may be bent or curved before degradation in the light transmission through the fiber occurs. The fiber begins to leak light from the core of the fiber due to the bend in the optical fiber. This loss of light from the optical fiber thereby increases the attenuation of the optical signals within the optical fiber. In addition, internal micromechancial stresses in the optical fiber caused by the tight bending can also physically degrade the optical fiber by reducing the amount of mechanical stress the fiber may endure prior to breaking.

To avoid light loss and maintain a useful longevity in a bent optical fiber, the turn typically requires a bend radius of 2 cm or more. This radius may be substantially reduced to as little as 50μ using a miniature bend. To form a miniature bend, the diameter along a length of bare fiber is reduced to as little as 1μ or less, by, for example, drawing, etching, or a combination thereof. In the reduced diameter region, the fiber conducts light by internal reflection at least partially due to the difference in index of refraction at the interface between the fiber and the surrounding environment, generally air. Thus, in this region, the fiber may be bent with no substantial light loss from the bend. See U.S. Pat. Nos. 5,138,676 and 5,452,383, the disclosures of which are incorporated by reference herein.

Small diameter fiber optic cables are typically terminated at each end in a connector, in a process referred to as connectorization. A connectorized cable is particularly susceptible to being damaged by being excessively bent at the point where optical fiber enters the connector beyond the bend radius of the cable where damage occurs.

One prior art solution to allowing connectorized cables to be used has been to include a flexible strain relief boot extending from the connector and encasing a section of the fiber optic cable. These strain relief boots are permanently attached to the fiber optic connector and are flexible enough to allow some bending of the optical fiber that is necessary for the proper routing and connection of the cable. However, the flexible strain relief boots are designed to prevent the cable from being damaged by limiting the amount of bend a cable is subjected to.

Even with flexible strain relief boots the installation of fiber optic cables in a junction box or to a connector panel may damage the fibers by over bending them. In many installations there may be tens or hundreds of fiber optic cables that are to be routed through junction boxes or connected to connector panels. These junction boxes and connector panels often have a limited volume of space available for the cabling process. The connectors of such fiber optic cables are commonly inserted horizontally into the junction boxes within which the connector panels are vertically oriented. The cables are often routed in a direction perpendicular to their connectors in the space between the connector panel and the external door. The door of the junction box or connector panel is also vertical and typically closes in a plane parallel to the connector panel. Typically, it is desirable for the space between the closed door and the connector panel to be as small as possible to minimize the space taken up by the junction box or connector panel. However, minimizing the space between the door and the connector panel may excessively bend the strain relief boot that encases a portion of the optical fiber thus forcing the fiber optic cable to bend excessively.

### BRIEF SUMMARY OF THE INVENTION

The present invention provides a connector that allows an optical fiber to be bent beyond the typical minimum bend radius close to the ferrule and while not increasing signal degradation due to the bend. More particularly, an angled fiber optic connector is disclosed in which a curved body portion includes an is interior passageway extending through the curved body portion and an optical fiber having a treated portion, wherein the treated portion is disposed within the interior passageway. In one aspect of the invention, the optical fiber has been treated with an annealing process to reduce the micromechanical stresses associated with bending or tightly curving an optical fiber. In another aspect of the invention, the optical fiber is treated by fusion tapering. In a further aspect of the invention, the optical fiber is treated by etching. The optical fiber can also be suspended within the internal passageway to prevent physical contact between the optical fiber and any of the interior surfaces of the passageway to prevent other optical losses.

The curved body portion is rigidly attached to a main body portion that includes a ferrule. The main body portion attaches to a connector adapter portion to allow mating with a complimentary connector adapter. In addition, a flexible strain relief boot may be attached to the curved body portion to provide an increased amount of strain relief. In another aspect of the angled fiber optic connector, a back body portion may be rigidly attached to the curved body portion. The back body portion may be used to facilitate attaching a flexible strain relief boot thereto using standard mating connectors.

Additional aspects, features and advantages of the present invention are also described in the following Detailed Description.

### BRIEF DESCRIPTION OF THE SEVERAL VIEWS OF THE DRAWING

The invention will be more fully understood from the following detailed description taken in conjunction with the accompanying drawings in which:

Fig.1 is a side cross sectional view of the angled fiber optic connector;

FIG. 2 is a side cross sectional view of another embodiment of the angled fiber optic connector;

FIG. 3 is a plan view of the side surface of the bent body portion of the angled fiber optic connector in FIGS. 1 and 2; and

FIG. 4 is a plan view of another embodiment of the bottom surface of the bent body portion of the angled fiber optic connector in FIGS. 1 and 2

### DETAILED DESCRIPTION OF THE INVENTION

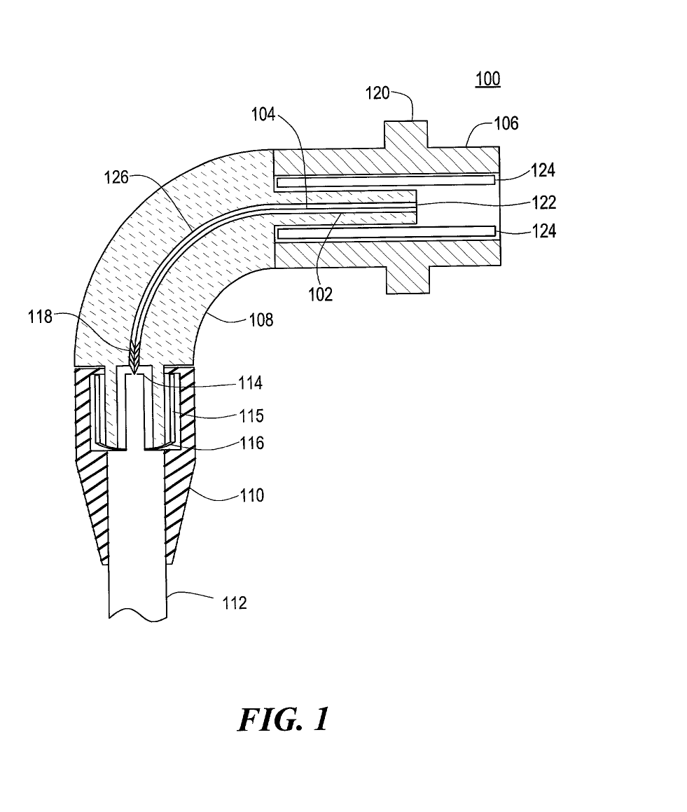

Referring to FIG. 1 an angled fiber optic connector 100 is illustrated. A fiber optic cable 112 enters a flexible boot 110 that is attached to a curved body portion 108. Typically, the flexible boot 110 and the curved body 108 are attached using some mechanical means such as a standard jack/clip system (not shown) and/or an epoxy. The flexible boot 110 may be made of any suitably flexible material that is able to flex and bend at arbitrary angles in response to externally applied forces. The fiber optic cable 112 passes through the flexible boot 110 and is rigidly attached to the curved body portion 108 in any suitable manner, for example by using a strength member 115 and a crimp ring 116. The outer cable layers and the jacketing material 114 of the fiber optic cable 112 are stripped free from the cable 112 leaving the optical fiber 104 free.

The optical fiber 104 is disposed with an interior passageway 126 of the curved body portion 108. The optical fiber 104 is secured within the passageway 126 using an epoxy or piece of plastic at one or both ends of the interior passageway 126.

A main body portion 106 is rigidly attached to the curved body portion 108, typically using a mechanical means (not shown) and/or an epoxy. The free end 122 of the optical fiber 104 is disposed within a ferrule 102 to ensure that an accurate mating connection with a second fiber (not shown) occurs. The ferrule 102 that is rigidly attached to the main body portion 106 fits within an alignment sleeve 124 that is contained within the connector adapter 120. The connector adapter 120 is rigidly attached to the main body 106. Typically the main body 106 and the connector adapter 120 have some mechanical means (not shown) to rigidly secure the main body portion 106 and the connector adapter 120 together. The connector adapter 120 may be configured to mate with a panel connector, another optical fiber connector, or may be an inline component.

The connector adapter portion 120 may be a standard fiber optic connector design to ensure that the interface between the ferrule from the angled fiber optic connector 100 and the ferrule of a mating connector (not shown) occurs in a precise and well understood manner. This helps to ensure that the necessary optical and environmental performance of the optical connection created by the two connectors meets the applicable optical and physical standards. The connector adapter 120 may be a standard commercial optical fiber connector, which may include, but should not be limited to, a FC, SC, LC, Biconic, ST, and D4 type optical fiber connectors. These standard fiber optic connectors also may include standard mechanical interface portions that can be used to rigidly secure the connector adapter 120 to the main body portion 106.

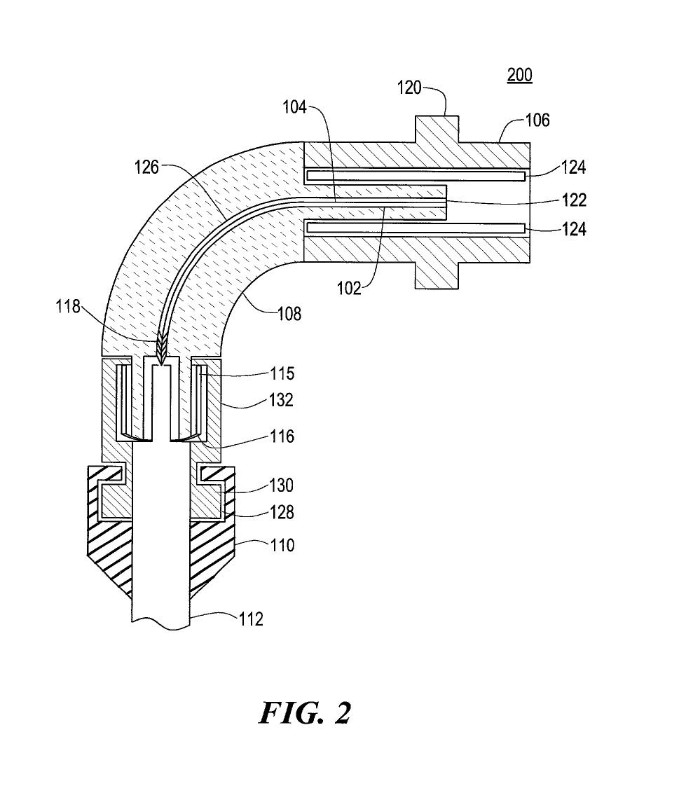

In some connector designs, such as an LC connector, a rear body portion is attached to the front body of the connector which holds the ferrule. In an alternative of the angled fiber optic connector illustrated in FIG. 2, the curved body portion 108 is rigidly connected to a back body portion 132, typically using a mechanical means (not shown) and/or an epoxy. Furthermore the back body portion 132 can be adapted to receive a standard jack/clip system used on a standard strain relief boot 110.

The curved body portion 108 can bend or curve the optical fiber 104 beyond the radius at which internal micromechanical stresses occur in the optical fiber 104. As discussed above, these micromechanical stresses can cause a degradation in the optical and physical performance of the optical fiber. This degradation can include increased attenuation of the optical signal, creation of other optical modes, and a reduction in the useable lifetime of the optical fiber. To prevent the optical fiber from degrading due to the bending, the fiber must be suitably treated by reducing the diameter to cause the fiber to conduct light by internal reflection as discussed above. However, the optical fiber can be further treated to reduce the amount of micromechanical stresses formed by the bending. By reducing the internal micromechanical stresses within the optical fiber, a bent optical fiber can have an optical performance and a useful lifetime that is comparable to the prior art fiber optic connectors.

The optical fibers 104 can be further treated using an annealing process to reduce the internal micromechanical stresses that occur within the bent or curved portion of the optical fiber. Preferably, the optical fiber annealing process includes heating the optical fiber 104 to a temperature of 1500 degrees F for a sufficient time to ensure that the necessary internal micromechanical stresses have been relieved. Typically, a few seconds at this temperature suffices to relieve the micromechanical stresses. Alternatively, the annealing process may also be carried out at a lower temperature but over a longer time period, or at a higher temperature for a shorter period of time.

The optical fiber 104 may be inserted and secured within the passageway 126 prior to the annealing process taking place. The heating process is typically performed prior to the curved body portion 108 being attached to the main body portion 106 and/or the flexible strain relief boot 110 or other rear body portion. Because of the high temperatures that are used, the curved body portion 108 should be fabricated from a high temperature material that is able to withstand the temperatures during processing without physically degrading. In a preferred embodiment, the curved body portion 108 can be constructed out of a ceramic material; however, other materials such as metals, filled epoxies, glass, and high temperature plastics may also be used.

Other methods that may be used to relieve the micromechanical stresses may be used as well. Other suitable treatments of the optical fiber 104 include fusion tapering of the curved portion of the optical fiber, etching the curved portion of the optical fiber, or a combination of fusion tapering and etching. These processes may be followed by subsequent annealing of the curved portion of the optical fiber, if necessary.

In addition to the micromechanical stresses causing an increase in attenuation of the optical signal, other optical losses may be caused by any physical contact between the optical fiber 104 and the interior surfaces of the passageway 126. Any contact between the optical fiber 104 and a material having an index of refraction greater than that of air can result in light leaking from the optical fiber. This leaking light results in the degradation of the optical signal carried by the optical fiber. Light is able to leak from the optical fiber when the critical angle, which defines the angle at which total internal reflection occurs, is changed by a material physically contacting the optical fiber that has an index of refraction greater than air.

These other optical losses may be avoided by preventing the optical fiber 104 from physically contacting the interior surface of the passageway 126. In one embodiment, the treated portion of the optical fiber 104 is suspended within the passageway 110 such that the optical fiber 104 does not physically contact the interior surfaces of passageway 126. The optical fiber 104 may be suspended within the passageway 126 with sufficient tension to avoid the optical fiber drooping and coming into contact with a surface of passageway 126. This suspension can be accomplished by securing the optical fiber 104 with a piece of plastic or epoxy on each end of the passageway 126 as the optical fiber 104 is held with sufficient tension to prevent the optical fiber from drooping. Alternatively, the optical fiber 104 may be secured at one or both ends of the passageway 126 but with less tension allowing the optical fiber 104 to droop within the passageway 126. To allow for the optical fiber 104 to droop within the passageway, the passageway is further hollowed out in some areas in which the optical fiber 104 droops the maximum amount, to prevent the optical fiber 104 from physically contacting the interior surfaces of the passageway 126. In one embodiment using an optical fiber 104 having a radius of 15-20 microns, the radius of the passageway 110 may be 0.75-1.0 millimeters.

Alternatively, an “optical signal loss penalty” may be incurred by allowing the optical fiber 104 to physically contact a portion of the interior surface in passageway 126. The optical signal loss penalty can be determined by calculation or measurement, and the resulting degradation of the signal is included in the system optical link calculations and design. Based on the system optical link characteristics, one skilled in the art would be able to determine the loss penalty that could be incurred before system performance is degraded beyond a predetermined threshold.

Some existing fiber optic connectors may utilize a “floating ferrule” design in which the optical fiber 104 is rigidly attached to the ferrule 102 and the ferrule 102 spring loaded and biased with an outward force from the front end portion. In order to accommodate a floating ferrule, the jacket and strength member of the optical fiber are rigidly attached only at the interface between the curved body portion and the back body portion or the flexible strain relief boot. In this way, as the connectors contact one other, the respective ferrules are biased back within the respective main body portions 106 creating slack within the optical fiber 104. The slack in the optical fiber 104 must be absorbed within the rigid curved connector portion 108.

Therefore, in the angled fiber optic connector 100 using a floating ferrule design, the optical fiber 104 is rigidly attached both to the ferrule tip and to the curved body portion 108. This allows the slack in the optical fiber 104 that is created by the retracting ferrule to be taken up within the passageway 126 within the curved body portion 108. The passageway 126 can be further hollowed out to allow the slack created by the retracting optic fiber to be taken up within the passageway 126 without the optical fiber 104 physically contacting the interior surface of passageway 110.

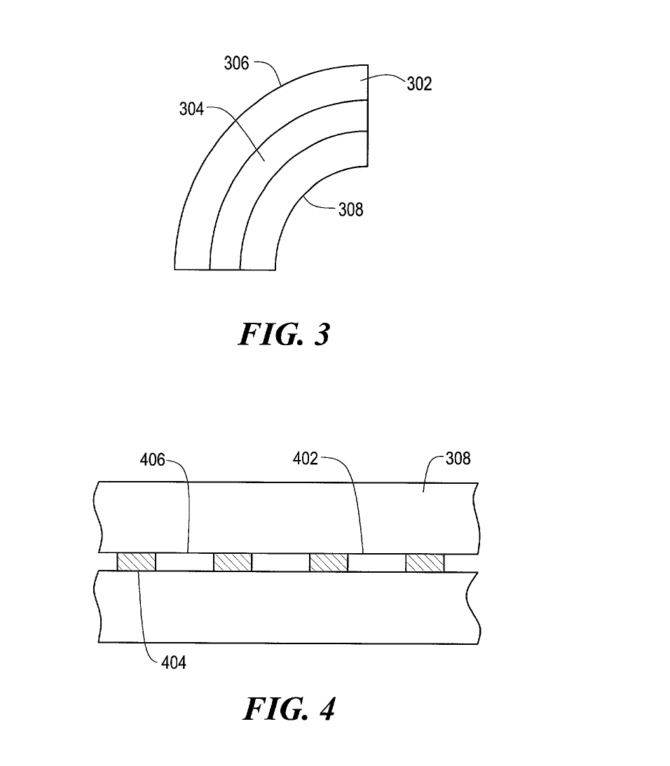

In an alternative embodiment illustrated in FIGS. 3 and 4, the passageway 126 of the curved body portion 108 can be a slot sized and dimensioned to allow the optical fiber to be contained therewithin. In the embodiment illustrated in FIG. 3, the slot or channel 304 may be on the side 302 or top 306 of the curved body portion 108. The optical fiber 104 can be placed in the slot 304 either before or after being annealed as described above.

In the embodiment illustrated in FIG. 4 the slot or channel 402 may be on the bottom 308 of the curved body portion 108. The optical fiber 104 can be placed in the slot or channel 402 and a filler material 404 such as an epoxy may be used to prevent the optical fiber from falling out of the slot or channel 402. The filler material 404 may include a plurality of filler material 404 spaced apart from one another, leaving spaces 406. If a slot is used, a cover such as a piece of heat shrinkable tubing (not shown) may be employed to prevent dust and debris from contacting the optical fiber 104 and causing a degradation in performance.

Having described the embodiments consistent with the present invention, other embodiments and variations consistent with the present invention will be apparent to those skilled in the art. Therefore, the invention should not be viewed as limited to the disclosed embodiments but rather should be viewed as limited only by the spirit and scope of the appended claims.

1. An angled fiber optic connector comprising:
a rigid curved body portion having an internal passageway, the internal passageway having a curved portion and extending through the rigid curved body portion; and
an optical fiber having a treated portion and a free end, said treated portion disposed within said internal passageway of said curved body portion, wherein said curved portion of said internal passageway bends said treated portion of said optical fiber and wherein said treated portion of said optical fiber has a reduced number of internal micromechanical stresses within said curved portion.

2. The angled fiber optic connector of claim 1 further comprising:
a main body portion rigidly attached to said curved body portion;
a ferrule attached to said main body portion, the ferrule having a front tip; and
said optical fiber being disposed within said main body portion and said ferrule, and said free end of said optical fiber being rigidly attached to said front tip of said ferrule.

3. The angled fiber optic connector of claim 1 further comprising:
a strain relief boot rigidly attached to said curved body portion, said strain relief boot having a passage way extending therethrough;
said optical fiber having a portion disposed within said passageway of said strain relief boot.

4. The angled fiber optic connector of claim 1 further comprising:
a rear body portion including a passage way extending therethrough;
said rear body portion being securely attached to said curved body portion
said optical fiber having a portion disposed within said passageway of said rear body portion.

5. The angled fiber optic connector of claim 4 further comprising:
said strain relief boot being securely attached to said rear body portion, said strain relief boot having a passageway extending therethrough; and
said optical fiber having a portion disposed within said passageway of said strain relief boot.

6. The angled fiber optic connector of claim 1 wherein said treated portion of said optical fiber has a reduced diameter.

7. The angled fiber optic connector of claim 6 wherein said treated portion of said optical fiber is annealed.

8. The angled fiber optic connector of claim 7 wherein said annealed portion of said optical fiber is heated to 1500 degrees F. for a time period of at least one second.

9. The angled fiber optic connector of claim 6 wherein said treated portion of said optical fiber is fusion tapered.

10. The angled fiber optic connector of claim 9 wherein said fusion tapered portion of said optical fiber is annealed.

11. The angled fiber optic connector of claim 6 wherein said treated portion of said optical fiber is etched.

12. The angled fiber optic connector of claim 11 wherein said etched portion of said optical fiber is annealed.

13. The angled fiber optic connector of claim 1 wherein said treated portion of said optical fiber disposed within said passageway of said curved body portion does not physically contact an interior surface of said passageway.

14. The angled fiber optic connector of claim 13 wherein said treated portion of said optical fiber disposed within said passageway of said curved body portion is suspended within said passageway of said curved body portion.

15. An angled fiber optic connector comprising:
a substantially rigid main body portion having first and second ends;
a ferrule rigidly attached to said first end of said main body portion, said ferrule having a tip end;
a curved body portion rigidly attached to said second surface of said main body portion, said curved body portion having an internal passageway extending therethrough;
an optical fiber having a treated portion disposed between first and second untreated portions, said treated bent portion being disposed in said internal passageway and said first untreated portion disposed within main body portion and rigidly connected to said tip end of said ferrule.

16. The fiber optic connector of claim 15 wherein said treated portion has a reduced diameter.

17. The fiber optic connector of claim 16 wherein said treated portion of said optical fiber is heated to 1500 degrees F. for a time period of at least one second.

18. The fiber optic connector of claim 16 wherein said treated portion of said optical fiber is fusion tapered.

19. The fiber optic connector of claim 16 wherein said treated bent portion of said optical fiber is etched

20. The angled fiber optic connector of claim 15 further including a slot disposed upon said curved body portion and said slot communicating with said internal passageway, wherein said treated bent portion of said optical fiber may be disposed within said passageway via said slot.

21. The angled fiber optic connector as in claim 20 further including a plurality of filler material disposed within said slot in a spaced apart manner, wherein the treated bent portion of said optical fiber is maintained within said passageway by said filler material.

22. The angled fiber optic connector of claim 15 further including a flexible strain relief boot flexibly attached to curved body portion, said strain relief boot having an internal passageway and said second untreated portion of said optical fiber is disposed within said internal passageway and extends through said strain relieve boot.

23. The angled optical fiber as in claim 15 further including a back connector portion being rigidly connected to said curved body portion.

24. The angled fiber optic connector of claim 23 further including a strain relief boot flexibly attached to said back body portion, and said second untreated portion of said optical fiber is disposed within said strain relief boot and extends through said strain relief boot.

25. The angled optical fiber as in claim 15 wherein said ferrule is constrained to move substantially linearly along an axis defined by said first passageway.

26. The angled optical fiber as in claim 15 wherein said treated portion of said optical fiber is disposed within said internal passageway so as not to contact an interior surface of said passageway.

27. The angled optical fiber as in claim 26 wherein said treated portion of said optical fiber is suspended within said internal passageway away from said interior surface of said passageway.

28. A method of producing an angled fiber optic connector comprising the steps of:
providing a curved body portion having an internal passageway;
providing a fiber optic cable;
reducing the diameter of a portion of said optical fiber;
shaping said reduced diameter portion of said optical fiber to said shape of said internal passageway;
heating said shaped portion of said optical fiber having said first radius of curvature to a sufficient temperature and for a sufficient time to anneal said shaped portion of said fiber optic cable;
inserting said shaped portion of said optical fiber having said first radius of curvature into said bent body portion; and
rigidly attaching said curved body portion to a main body portion;
rigidly attaching said curved body portion to a rear portion.

29. The method of claim 28 wherein said heating step comprises, heating said shaped portion of said optical fiber to a temperature of 1500 degrees F for a time period of at least one second.

30. The method of claim 28 wherein said rear body portion is a strain relief boot.

31. The method of claim 28 wherein said rear portion is a rear body portion.
